(19) United States
(12) Patent Application Publication
(10) Pub. No.: US 2024/0295777 A1
(43) Pub. Date: Sep. 5, 2024

(54) LIQUID CRYSTAL DISPLAY PANEL AND DISPLAY DEVICE

(71) Applicants: Hefei Xinsheng Optoelectronics Technology Co., Ltd., Hefei, Anhui (CN); BOE Technology Group Co., Ltd., Beijing (CN)

(72) Inventors: Jinliang HU, Beijing (CN); Xiaofeng YIN, Beijing (CN); Jian MA, Beijing (CN); Lei ZHU, Beijing (CN); Chengyong ZHAN, Beijing (CN); Wenming REN, Beijing (CN)

(21) Appl. No.: 17/913,018

(22) PCT Filed: Nov. 9, 2021
(86) PCT No.: PCT/CN2021/129568

§ 371 Date: Sep. 20, 2022

(30) Foreign Application Priority Data
Mar. 19, 2021 (CN) 202120594320.X

(51) Int. Cl. G02F 1/1339; G02F 1/1362; G02F 1/1368

(52) U.S. Cl. CPC G02F 1/13394; G02F 1/13396; G02F 1/136227; G02F 1/136286; G02F 1/1368

(57) ABSTRACT

Provided is a liquid crystal display panel, including an array substrate and a color filter substrate that are arranged oppositely, and a plurality of photo spacers disposed between the array substrate and the color filter substrate. The array substrate is provided with a plurality of via holes, wherein the plurality of via holes are arranged in an array along two directions. In at least one of the two directions, widths of target end faces of at least part of the plurality of photo spacers are greater than widths of first opening faces of the via holes, wherein the target end face of the photo spacer is an end face, proximal to the array substrate, of the photo spacer, and the first opening face of the via hole is an opening face, proximal to the color filter substrate, of the via hole.

### CROSS-REFERENCE TO RELATED APPLICATION

This application is a U.S. national stage of international application No. PCT/CN2021/129568, field on Nov. 9, 2021, which claims priority to Chinese Patent Application No. 202120594320.X, filed on Mar. 19, 2021 and entitled “LIQUID CRYSTAL DISPLAY PANEL AND DISPLAY DEVICE,” the contents of which are herein incorporated by reference in their entireties.

### TECHNICAL FIELD

The present disclosure relates to the field of display technologies, and in particular, relates to a liquid crystal display panel and a display device.

### BACKGROUND

A liquid crystal display panel is a common display panel, which has advantageous of low manufacturing costs and simple manufacturing process, and has a large market share in the field of display technologies.

### SUMMARY

Embodiments of the present disclosure provide a liquid crystal display panel and a display device.

In one aspect of some embodiments of the present disclosure, a liquid crystal display panel is provided. The liquid crystal display panel includes:
an array substrate and a color filter substrate that are arranged oppositely, wherein the array substrate is provided with a plurality of via holes, the plurality of via holes being arranged in an array along two directions; and
a plurality of photo spacers disposed between the array substrate and the color filter substrate;
wherein in at least one of the two directions, widths of target end faces of at least part of the plurality of photo spacers are greater than widths of first opening faces of the via holes, wherein the target end face of the photo spacer is an end face, proximal to the array substrate, of the space, and the first opening face of the via hole is an opening face, proximal to the color filter substrate, of the via hole.

Optionally, the plurality of photo spacers include: a plurality of first photo spacers and a plurality of second photo spacers, wherein a height of the first photo spacer is greater than a height of the second photo spacer, and in at least one of the two directions, a width of a target end face of the second photo spacer is greater than the width of the first opening face of the via hole.

Optionally, an area of a target end face of the first photo spacer is less than an area of the first opening face of the via hole.

Optionally, a minimum distance between the first photo spacer and the via hole is greater than a minimum distance between the second photo spacer and the via hole.

Optionally, the two directions include a first direction and a second direction that are intersected with each other; and the liquid crystal display panel includes a plurality of sub-pixel regions; wherein a width of the sub-pixel region in the first direction is less than a width of the sub-pixel region in the second direction;
the width of the first opening face of the via hole in the first direction is less than the width of the first opening face of the via hole in the second direction; and
the width of the target end face of the photo spacer in the first direction is greater than the width of the target end face of the photo spacer in the second direction, and greater than the width of the first opening face of the via hole in the first direction.

Optionally, the target end face of the photo spacer is circular or rectangular; and the first opening face of the via hole is circular or octagonal.

Optionally, in at least one of the two directions, a difference between the width of target end face of the photo spacer and the width of the first opening face of the via hole ranges from 2 μm to 10 μm.

Optionally, in the two directions, the width of the first opening face of the via hole ranges from 10 μm to 16 μm, and a width of a second opening face of the via hole ranges from 6 μm to 12 μm, wherein the second opening face of the via hole is an opening face, distal form the color filter substrate, of the via hole.

Optionally, the array substrate includes: an organic insulative layer, a plurality of thin-film transistors disposed on a side of the organic insulative layer, and a plurality of pixel electrodes disposed on the other side of the organic insulative layer, wherein the plurality of via holes are disposed in the organic insulative layer, and the pixel electrode is electrically connected to the thin-film transistor by the via hole; and

the array substrate further includes: a plurality of gate lines and a plurality of data lines that are electrically connected to the plurality of thin-film transistors, wherein the plurality of gate lines are crosswise arranged with the plurality of data lines, an orthographic projection of the photo spacers on the array substrate being overlapped with a cross region between the gate lines and the data lines.

In another aspect of some embodiments of the present disclosure, a display device is provided. The display device includes: a backlight source and the liquid crystal display panel as described above.

### BRIEF DESCRIPTION OF THE DRAWINGS

For clearer descriptions of the technical solutions in the embodiments of the present disclosure, the following briefly introduces the accompanying drawings to be required in the descriptions of the embodiments. Apparently, the accompanying drawings in the following description show merely some embodiments of the present disclosure, and persons of ordinary skills in the art may still derive other drawings from these accompanying drawings without creative efforts.

FIG. 1 is a top view of a common liquid crystal display panel;

FIG. 2 is a schematic structural diagram of a film layer at a line A-A′ of a liquid crystal display panel shown in FIG. 1:

FIG. 3 is an effect diagram of a possible defect of a via hole after a size of the via hole is reduced:

FIG. 4 is an effect diagram of another possible defect of a via hole after a size of the via hole is reduced:

FIG. 5 is a top view of a liquid crystal display panel according to some embodiments of the present disclosure:

FIG. 6 is a schematic structural diagram of a film layer at a line A-A′ of a liquid crystal display panel shown in FIG. 5:

FIG. 7 is a top view of another liquid crystal display panel according to some embodiments of the present disclosure:

FIG. 8 is a schematic structural diagram of a film layer at a line A-A′ of an array substrate shown in FIG. 7; and

FIG. 9 is a top view of still another liquid crystal display panel according to some embodiments of the present disclosure.

### DETAILED DESCRIPTION

The present disclosure is described in further detail with reference to the accompanying drawings, to clearly present the objects, technical solutions, and advantages of the present disclosure.

The liquid crystal display panel generally includes: an array substrate and a color filter substrate that are arranged oppositely, and a liquid crystal layer disposed between the array substrate and the color filter substrate. Typically, a plurality of columnar photo spacers (PS) are arranged between the array substrate and the color filter substrate. The photo spacers support the array substrate and the color filter substrate, such that the uniformity of the thickness of the liquid crystal display panel is ensured.

The array substrate of the liquid crystal display panel generally includes a plurality of via holes, wherein the via hole is configured to connect a pixel electrode to a thin-film transistor in the array substrate. When the liquid crystal display panel is subjected to an external force, the columnar photo spacer is exceedingly prone to fall into the via hole, and the columnar photo spacer, once falling into the via hole, is difficult to be recovered. In this way, the array substrate and the color filter substrate are misaligned, such that color cast occurs in pictures displayed by the liquid crystal display panel, and thus the liquid crystal display panel has a poor display effect.

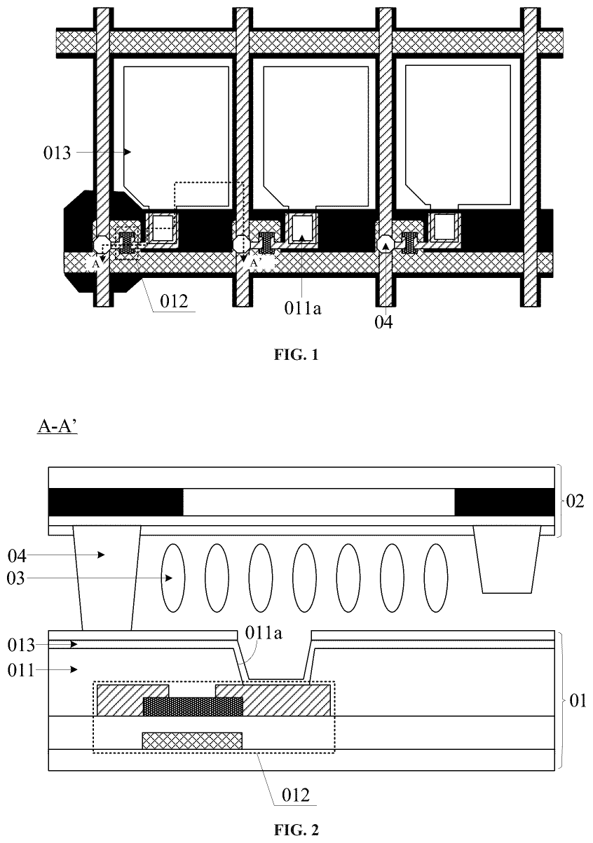

FIG. 1 is a top view of a common liquid crystal display panel. FIG. 2 is a schematic structural diagram of a film layer at a line A-A′ of a liquid crystal display panel shown in FIG. 1. Referring to FIG. 1 and FIG. 2, the liquid crystal display panel includes: an array substrate 01 and a color filter substrate 02 that are arranged oppositely, and a liquid crystal layer 03 and a columnar photo spacer 04 that are disposed between the array substrate 01 and the color filter substrate 02. One end of the columnar photo spacer 04 is fixedly connected to the color filter substrate 02. The other end of the columnar photo spacer 04 is a free end, which is capable of sliding relative to the array substrate 01.

The array substrate 01 includes: an organic insulative layer 011, a plurality of thin-film transistors 012 disposed on a side of the organic insulative layer 011, and a plurality of pixel electrodes 013 disposed on the other side of the organic insulative layer 011. The organic insulative layer 011 is provided with a plurality of via holes 011a. The plurality of via holes 011a, the plurality of thin-film transistors 012, and the plurality of pixel electrodes 013 are in one-to-one correspondence with each other. Each of the pixel electrodes 013 is electrically connected to a corresponding thin-film transistor 012 by a corresponding via hole 011a.

An area of an opening face of a side, proximal to the color filter film 02, of the via hole 011a is generally greater than an area of an end face of an end, proximal to the array substrate 01, of the columnar photo spacer 04, and the columnar photo spacer 04 is generally proximal to the via hole 011a. Therefore, when the liquid crystal display panel is subjected to an external force, the end, proximal to the array substrate 01, of the columnar photo spacer 04 slides relative to the array substrate 01, such that the columnar photo spacer 04 is exceedingly prone to fall into the via hole 011a. The columnar photo spacer 04, once falling into the via hole 011a, is difficult to be recovered. In this way, the array substrate 01 and the color filter substrate 02 are misaligned, such that color cast occurs in pictures displayed by the liquid crystal display panel, and thus the liquid crystal display panel 01 has a poor display effect.

At present, a size of the via hole 011a needs to be reduced in order to prevent the columnar photo spacer 04 from falling into the via hole 011a. That is, areas of two opening faces of the via hole 011a need to be reduced. However, in a case that the size of the via hole 011a is reduced, the via hole 011a has the following two possible defects.

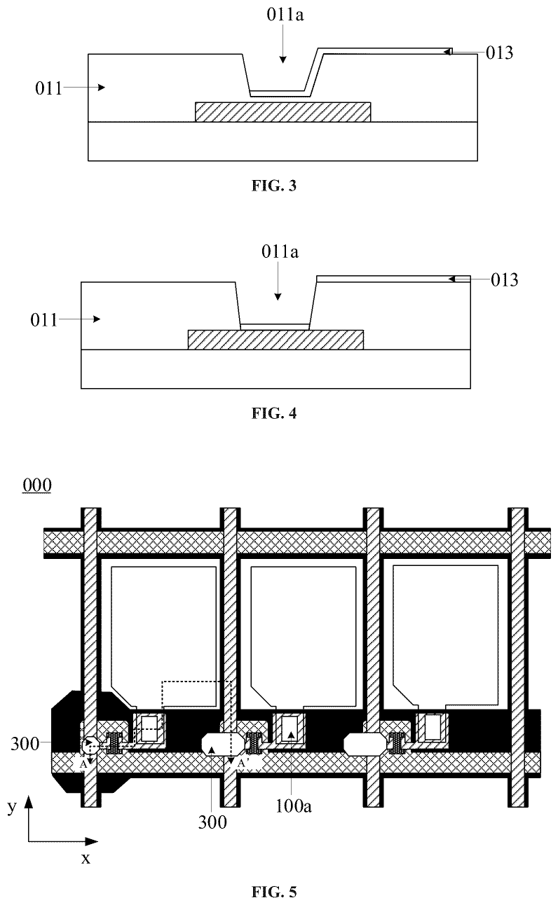

FIG. 3 is an effect diagram of a possible defect of a via hole after a size of the via hole is reduced. A first possible defect is shown in FIG. 3. The size of the via hole 011a is small, and thus when the via hole 011a is formed in the organic insulative layer 011 by an etching process, an insulative material in the via hole 011a is not etched completely, and the unetched insulative material is exceeding prone to remain at a bottom of the via hole 011a. In this way, lapping between the pixel electrode 013 of the array substrate 01 and an electrode of the thin-film transistor 012 is affected, and thus the display of the liquid crystal display panel is further affected.

FIG. 4 is an effect diagram of another possible defect of a via hole after a size of the via hole is reduced. A second possible defect is shown in FIG. 4. Because the size of the via hole 011a is small, a slope of the via hole 011a is large. When the pixel electrode 013 of the array substrate 01 is lapped with the electrode of the thin-film transistor 012 by the via hole 011a, a part, on a sidewall of the via hole 011a, of the pixel electrode 013 is prone to breakage, such that the display of the liquid crystal display panel is affected.

To avoid the problem that the display of the liquid crystal display panel is affected by the defects of the via hole upon reduction of the size of the via hole, in the liquid crystal display panel shown in the following embodiments, the size of the via hole is not adjusted, but a size of the photo spacer in the liquid crystal display panel is appropriately increased to prevent the photo spacer from falling into the via hole.

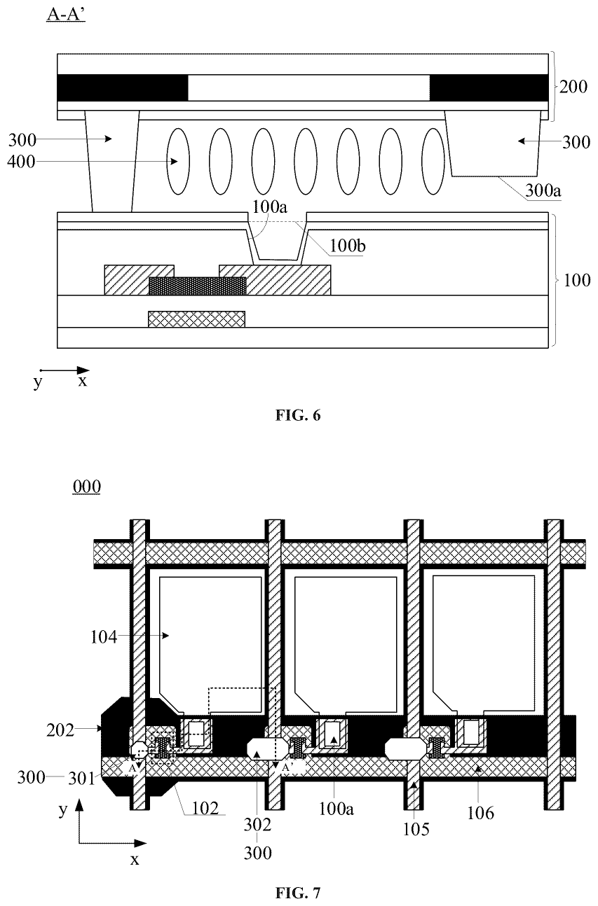

FIG. 5 is a top view of a liquid crystal display panel according to some embodiments of the present disclosure. FIG. 6 is a schematic structural diagram of a film layer at a line A-A′ of a liquid crystal display panel shown in FIG. 5.

Referring to FIG. 5 and FIG. 6, the liquid crystal display panel 000 includes: an array substrate 100 and a color filter substrate 200 that are arranged oppositely, and a plurality of photo spacers 300 disposed between the array substrate 100 and the color filter substrate 200. The photo spacer 300 is generally columnar. One end of the photo spacer 300 is fixedly connected to the color filter substrate 200, and the other end of the photo spacer 300 is a free end, which is capable of sliding freely relative to the array substrate 100. In the embodiments of the present disclosure, the liquid crystal display panel 000 further includes: a liquid crystal layer 400 disposed between the array substrate 100 and the color filter substrate 200.

The array substrate 100 is provide with a plurality of via holes 100a arranged in an array along two directions. For example, the two directions include: a first direction x and a second direction y that are intersected with each other. A gate line (not shown) and a data line (not show) are generally arranged in the array substrate 100. The first direction x is parallel to an extension direction of the gate line, and the second direction y is parallel to an extension direction of the data line. For example, the first direction x is perpendicular to the second direction y.

In at least one of the two directions, widths of target end faces 300a of at least part of the plurality of photo spacers 300 are greater than widths of first opening faces 100b of the via holes 100a. The target end face 300a of the photo spacer 300 is an end face, proximal to the array substrate 100, of the photo spacer 300. The first opening face 100b of the via hole 100a is an opening face, proximal to the color filter substrate 200, of the via hole 100a.

In the embodiments of the present disclosure, in at least one of the first direction x and the second direction y, widths of target end faces 300a of at least part of the plurality of photo spacers 300 are greater than widths of first opening faces 100b of the via holes 100a. Therefore, when the liquid crystal display panel 000 is subjected to an external force, the at least part of photo spacers 300 do not fall into the via holes 100a even though ends, proximal to the array substrate 100, of the at least part of photo spacers 300 slide relative to the array substrate 100. In this way, the probability of misalignment between the array substrate 100 and the color filter substrate 200 is reduced effectively.

In summary, the liquid crystal display panel according to the embodiments of the present disclosure includes: the array substrate and the color filter substrate that are arranged oppositely, and the plurality of photo spacers disposed between the array substrate and the color filter substrate. In at least one of the first direction and the second direction, the widths of the target end faces of at least part of the plurality of photo spacers are greater than the widths of the first opening faces of the via holes. Therefore, when the liquid crystal display panel is subjected to an external force, the at least part of photo spacers do not fall into the via holes, even though the ends, proximal to the array substrate, of the at least part of photo spacers slide relative to the array substrate. In this way, the probability of misalignment between the array substrate and the color filter substrate is reduced effectively, such that the probability of color cast occurring in pictures displayed by the liquid crystal display panel is reduced, and thus the liquid crystal display panel has a great display effect.

FIG. 7 is a top view of another liquid crystal display panel according to some embodiments of the present disclosure. FIG. 8 is a schematic structural diagram of a film layer at a line A-A′ of an array substrate shown in FIG. 7. In the embodiments of the present disclosure, referring to FIG. 7 and FIG. 8, the plurality of photo spacers 300 of the liquid crystal display panel 000 include: a plurality of first photo spacers 301 and a plurality of photo spacers 302. A height of the first photo spacers 301 is greater than a height of the second photo spacers 302. When the liquid crystal display panel 000 is not subjected to an external force, an end, proximal to the array substrate 100, of the first photo spacer 301 is in contact with the array substrate 100, an end, proximal to the array substrate 100, of the second photo spacer 302 is not in contact with the array substrate 100, and thus the first photo spacer 301 supports the array substrate 100 and the color filter substrate 200; and when the liquid crystal display panel 000 is subjected to an external force, the end, proximal to the array substrate 100, of the first photo spacer 301 and the end, proximal to the array substrate 100, of the second photo spacer 302 are both in contact with the array substrate 100, and thus the first photo spacers 301 and the second photo spacers 302 support the array substrate 100 and the color filter substrate 200. It should be noted that, the first photo spacer 301 with a higher height is generally referred to as a primary photo spacer, and the second photo spacer 302 with a lower height is generally referred to as a secondary photo spacer.

In the embodiments of the present disclosure, referring to FIG. 7 and FIG. 8, the array substrate 100 of the liquid crystal display panel 000 includes: a first substrate 101, and a plurality of thin-film transistors 102, an organic insulative layer 103, and a plurality of pixel electrodes 104 that are disposed on the first substrate 101. The plurality of thin-film transistors 102 are disposed on a side, proximal to the first substrate 101, of the organic insulative layer 103, and the plurality of pixel electrodes 104 are disposed on a side, distal form the first substrate 101, of the organic insulative layer 103. The plurality of via holes 100a of the array substrate 100 are disposed in the organic insulative layer 103. A thickness of the organic insulative layer 103 ranges from 2 μm to 2.5 μm. The pixel electrode 104 is electrically connected to the thin-film transistor 102 by the via hole 100a.

Exemplarily, each of the thin-film transistors 102 in the array substrate 100 includes: a gate electrode 1021, an active layer 1022 insulated from the gate electrode 1021, and a first electrode 1023 and a second electrode 1024 that are lapped with the active layer 1022. The gate electrode 1021 is insulated from the active layer 1022 by a gate electrode insulative layer 1025. In the embodiments of the present disclosure, the plurality of thin-film transistors 102, the plurality of pixel electrodes 104, and the plurality of via holes 100a are in one-to-one correspondence with each other. Each of the pixel electrodes 104 is electrically connected to a first electrode 1023 of a corresponding thin-film transistor 102 by a corresponding via hole 100a. It should be noted that, the first electrode 1023 of the thin-film transistor 102 is one of a source electrode and a drain electrode, and the second electrode 1024 of the thin-film transistor 102 is the other of a source electrode and a drain electrode.

In the embodiments of the present disclosure, the array substrate 100 further includes: a plurality of gate lines 106 and a plurality of data lines 105 that are electrically connected to the plurality of thin-film transistors 102. The plurality of gate lines 106 are crosswise arranged with the plurality of data lines 105. For example, the gate line 106 is electrically connected to the gate electrode 1021 of the thin-film transistor 102, and the data line 105 is electrically connected to the second electrode 1024 of the thin-film transistor 102. An extension direction of the gate line 106 is parallel to the first direction x, and an extension direction of the data line 105 is parallel to the second direction y. In the embodiments of the present disclosure, an orthographic projection of the photo spacer 300 of the liquid crystal display panel 000 on the array substrate 100 is overlapped with a cross region between the gate line 106 and the data line 105.

Referring to FIG. 7 and FIG. 8, the color filter substrate 200 of the liquid crystal display panel 000 includes: a second substrate 201, and a black matrix 202, a color filter layer 203, and a common electrode 204 that are disposed on the second substrate 201. The black matrix 202 is generally grid-shaped, and covers the gate line 106 and the data line 105. The black matrix 202 prevents the ambient light from being reflected by the gate line 106 and the data line 105, such that a display effect of the liquid crystal display panel 000 is improved. The color filter layer 203 generally includes: color filters of at least two colors. For example, the color filters of at least two colors include: a red filter, a green filter, and a blue filter. The color filter layer 203 enables the liquid crystal display panel 000 to display colorful pictures. The common electrode 105 is generally a planar electrode.

In the embodiments of the present disclosure, for regular arrangement of liquid crystal molecules in the liquid crystal layer 400 of the liquid crystal display panel 000, a first alignment film 107 is arranged on a side, distal from the plurality of pixel electrodes 104, of the array substrate 100, and a second alignment film 205 is arranged on a side, distal from the common electrode 204, of the color filter substrate 200. Two sides of the liquid crystal layer 400 of the liquid crystal display panel 000 are respectively in contact with the first alignment film 107 and the second alignment layer 205. The liquid crystal molecules in the liquid crystal layer 400 are caused to be regularly arranged by the first alignment film 107 and the second alignment layer 205.

It should be noted that, in a case that the liquid crystal display panel 000 is subjected to an external force, an end, proximal to the array substrate 100, of the photo spacer 300 of the liquid crystal display panel 000 slides relative to the array substrate 100, such that the end, proximal to the array substrate 100, of the photo spacer 300 of the liquid crystal display panel 000 is exceedingly prone to scratch the first alignment film 107 of the array substrate 100. In this way, liquid crystal molecules in a region where the first alignment film 107 is scratched are not properly aligned, causing defects such as light leakage. Therefore, the black matrix 202 needs to be configured to shield the region scratched by the photo spacer 300 in the first alignment film 107.

Therefore, the larger the scratched region in the first alignment film 107 is, the smaller a pixel aperture ratio of the liquid crystal display panel 000 is. The second photo spacer 302 of the plurality of photo spacers 300 is in contact with the array substrate 100 only in the case that the liquid crystal display panel 000 is subjected to an external force, whereas the first photo spacer 301 of the plurality of photo spacers 300 is in contact with the array substrate 100 no matter whether the liquid crystal display panel 000 is subjected to an external force or not. Therefore, compared with the second photo spacer 302, the first photo spacer 301 is more prone to scratch the first alignment film 107 of the array substrate 100. An area of the region scratched by the photo spacer 300 in the first alignment film 107 is positively correlated with an area of the target end face 300a of the photo spacer 300. In the embodiments of the present disclosure, to reduce the probability that the photo spacer 300 affects the pixel aperture ratio of the liquid crystal display panel, an area of a target end face 300a of the first photo spacer 301 needs to be less than an area of a target end face of the second photo spacer 302.

In this case, in at least one of the first direction x and the second direction y, a width of the target end face 300a of the second photo spacer 302 in the plurality of photo spacers 300 is greater than the width of the first opening face 100b of the via hole 100a, whereas the area of the target end face 300a of the first photo spacer 301 in the plurality of photo spacers 300 is less than an area of the first open end face 100b of the first via hole. That is, in the embodiments of the present disclosure, only a size of the target end face 300a of the second photo spacer 302 is enlarged, and a size of the target end face 300a of the first photo spacer 301 is not adjusted. In this way, on the premise that the probability of the misalignment between the array substrate 100 and the color filter substrate 200 that are in the liquid crystal display panel 000 is low, the pixel aperture ratio of the liquid crystal display panel 000 is improved as much as possible.

Is should be noted that, when the area of the target end face 300a of the first photo spacer 301 is less than the area of the first opening face 100b of the via hole 100a, in the case that the liquid crystal display panel 000 is subjected to an external force, the first photo spacer 301 falls into the via hole 100a, but the second photo spacer 302 does not fall into the via hole 100a. In a case that the second photo spacer 302 is in contact with the array substrate 100, the second photo spacer 302 supports the array substrate 100 and the color filter substrate 200. Under the supporting force, the first photo spacer 301 is removed from the via hole 100a.

It should be also noted that, when the area of the target end face 300a of the first photo spacer 301 is less, the first pacer 301 exerts a small supporting effect on the array substrate 100 and the color filter substrate 200. In this way, in the case that the liquid crystal display panel 000 is subjected to an external force, the liquid crystal molecules in the liquid crystal display panel 000 quickly recover to a non-stressed state, such that the probability of light leakage when the liquid crystal display panel 000 is in a dark state is reduced, and thus a display effect in the dark state of the liquid crystal display panel is improved.

Optionally, in the plurality of photo spacers 300, a minimum distance between the first photo spacer 301 and the via hole 100a is greater than a minimum distance between the second photo spacer 302 and the via hole 100a. In this way, the first photo spacer 301 is far from the via hole 100a, and the probability that the first photo spacer 301 falls into the via hole 100a is reduced.

In the embodiments of the present disclosure, the liquid crystal display panel 000 is provided with a plurality of sub-pixel regions (not shown). Each of the pixel electrodes 104 of the array substrate 100 is disposed in one of the sub-pixel regions, and each of the color filters of the color filter substrate 200 is also disposed in one of the sub-pixel regions. A width of the sub-pixel region in the first direction x is less than a width of the sub-pixel region in the second direction y. For example, in the case that the sub-pixel region is rectangular, a short-side direction of the sub-pixel region is parallel to the first direction x, and a long-side direction of the sub-pixel region is parallel to the second direction y.

Assuming that a distance at which the sub-pixel region shrinks along a direction perpendicular to the short-side direction (i.e., the second direction y) is equal to a distance that the sub-pixel region shrinks along a direction perpendicular to the long-side direction (i.e., the first direction x), then an area of the sub-pixel region after shrinking along the direction perpendicular to the short-side direction is greater than an area of the sub-pixel region after shrinking along the direction perpendicular to the long-side direction. That is, an area of the sub-pixel region is less affected when the sub-pixel region shrinks along the direction perpendicular to the short-side direction; whereas an area of the sub-pixel region is greatly affected when the sub-pixel region shrinks along the direction perpendicular to the long-side direction.

Therefore, when a width of the first opening face 100b of the via hole 100a in the first direction x is less than a width in the second direction y, and a width of the target end face 300a of the photo spacer 300 in the first direction x is greater than a width in the second direction, the width of the target end face 300a of the photo spacer 300 in the first direction x is greater than the width of the first opening face 100b of the via hole 100a in the first direction x. In this way, when the photo spacer 300 slides along the first direction x and the second direction y, the black matrix 202 extending along the first direction x effectively shields the region in the first alignment film 107 scratched by the photo spacer 300, and widths of the black matrix 202 in the first direction x and the second direction y do not need to be increased. Even though the region scratched by the photo spacer 300 in the first alignment film 107 increases due to the increase of the area of the target end face 300a of the photo spacer 300, it is only necessary to increase the width of the black matrix 202 extending along the first direction x, with no need to increase the width of the black matrix 202 extending along the second direction y. When the width of the black matrix 202 extending along the first direction x is increased, the sub-pixel region shrinks along the second direction y, such that the area of the sub-pixel region is less affected, and thus the widened black matrix 202 exerts a smaller effect on the pixel aperture ratio of the liquid crystal display panel 000.

Optionally, the target end face 300a of the photo spacer 300 of the liquid crystal display panel 000 is circular or rectangular; and the first opening face 100b of the via hole 100a in the array substrate 100 is circular or octagonal.

In the embodiments of the present disclosure, because a size of the via hole 100a in the array substrate 100 is large, the via hole 100a does not have the defects. For example, in the first direction x and the second direction y, the width of the first opening face 100b of the via hole 100a ranges from 10 μm to 16 μm, and a width of a second opening face 100c of the via hole 100a ranges from 6 μm to 12 μm. The second opening face 100c is an opening face, distal from the color filter substrate 200, of the via hole 100a.

Optionally, in at least one of the first direction x and the second direction y, a difference between the width of the target end face 300a of the photo spacer 300 and the width of the first opening face 100b of the via hole 100a ranges from 2 μm to 10 μm. That is, the width of the target end face 300a of the photo spacer 300 is greater than the width of the first opening face 100b of the via hole 100a by 2 μm to 10 μm.

In conjunction with the above embodiments, two possible implementations are listed below to describe the sizes and shapes of the photo spacer and the via hole in the liquid crystal display panel.

Referring to FIG. 7, in a first possible implementation, in the liquid crystal display panel 000, the target end face of the first photo spacer 301 and the target end face of the second photo spacer 302 are both octagonal; and the first opening face 100b and the second opening face (not shown) of the via hole 100a are both rectangular.

The width of the first opening face 100b of the via hole 100a in the first direction x is 13.5 μm, and the width in the second direction y is 15 μm. The width of the second opening face of the via hole 100a in the first direction x is 9.5 μm, and the width in the second direction y is 11 μm. The width of the target end face of the first photo spacer 301 in the first direction x is 13 μm, and the width in the second direction y is 13 μm. The width of the target end face of the second photo spacer 302 in the first direction x is 23 μm, and the width in the second direction y is 17 μm.

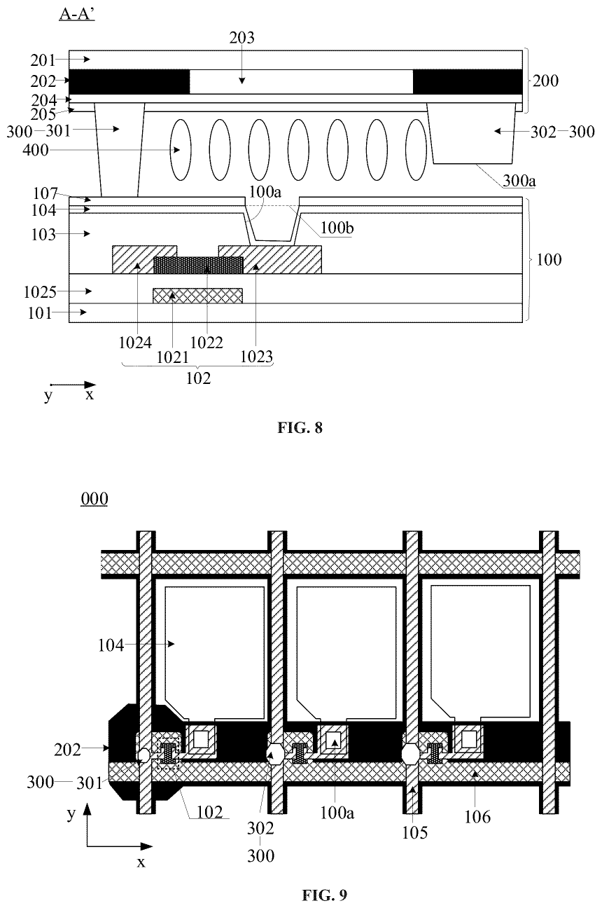

FIG. 9 is a top view of still another liquid crystal display panel according to some embodiments of the present disclosure. Referring to FIG. 9, in a second possible implementation, in the liquid crystal display panel 000, the target end face of the first photo spacer 301 and the target end face of the second photo spacer 302 are both octagonal; and the first opening face 100b and the second opening face (not shown) of the via hole 100a are both rectangular.

The width of the first opening face 100b of the via hole 100a in the first direction x is 11 μm, and the width in the second direction y is 11 μm. The width of the second opening face of the via hole 100a in the first direction x is 7 μm, and the width in the second direction y is 7 μm. The width of the target end face of the first photo spacer 301 in the first direction x is 11 μm, and the width in the second direction y is 11 μm. The width of the target end face of the second photo spacer 302 in the first direction x is 13 μm, and the width in the second direction y is 13 μm.

In summary, the liquid crystal display panel according to the embodiments of the present disclosure includes: the array substrate and the color filter substrate that are arranged oppositely, and the plurality of photo spacers disposed between the array substrate and the color filter substrate. In at least one of the first direction and the second direction, the widths of the target end faces of at least part of the plurality of photo spacers are greater than the widths of the first opening faces of the via holes. Therefore, when the liquid crystal display panel is subjected to an external force, the at least part of photo spacers do not fall into the via holes, even though the ends, proximal to the array substrate, of the at least part of photo spacers slide relative to the array substrate. In this way, the probability of misalignment between the array substrate and the color filter substrate is reduced effectively, such that the probability of color cast occurring in the pictures displayed by the liquid crystal display panel is reduced, and thus the liquid crystal display panel has a great display effect.

The embodiments of the present disclosure provide a display device. The display device includes: a backlight source, and the liquid crystal display panel as described above. For example, the liquid crystal display panel is the liquid crystal display panel shown in FIG. 5, FIG. 6, or FIG. 7. The backlight source is configured to provide a light source to the liquid crystal display panel, such that the liquid crystal display panel displays pictures. The display device is an electronic paper, a smart phone, a table computer, a television, a display, a notebook computer, a digital photo frame, a navigator, and any other products with a display function.

It should be pointed out that in the accompanying drawings, the sizes of layers and regions may be exaggerated for clearer illustration. It should be understood that in the case that an element or layer is referred to as being “on” another element or layer, it may be directly on another element, or intervening layers may be present. In addition, it should be understood that in the case that an element or layer is referred to as being “under” another element or layer, the layer may be directly under the other element, or there may be more than one intervening layer or element. In addition, it can further be understood that in the case that a layer or element is referred to as being “between” two layers or two elements, the layer may be the only layer between the two layers or two elements, or more than one intervening layer or element may also be present. Similar reference numerals indicate similar elements throughout.

In the present disclosure, the terms “first” and “second” are only used for descriptive purposes, and cannot be understood as indicating or implying relative importance. The term “a plurality of” refers to two or more, unless expressly defined otherwise.

Described above are merely exemplary embodiments of the present disclosure, and are not intended to limit the present disclosure. Therefore, any modifications, equivalent substitutions, improvements, and the like made within the spirit and principles of the present disclosure shall be included in the protection scope of the present disclosure.

1. A liquid crystal display panel, comprising:
an array substrate and a color filter substrate that are arranged oppositely, wherein the array substrate is provided with a plurality of via holes, the plurality of via holes being arranged in an array along two directions; and
a plurality of photo spacers disposed between the array substrate and the color filter substrate;
wherein in at least one of the two directions, widths of target end faces of at least part of the plurality of photo spacers are greater than widths of first opening faces of the via holes, wherein the target end face of the photo spacer is an end face, proximal to the array substrate, of the photo spacer, and the first opening face of the via hole is an opening face, proximal to the color filter substrate, of the via hole.

2. The liquid crystal display panel according to claim 1, wherein the plurality of photo spacers comprise: a plurality of first photo spacers and a plurality of second photo spacers, wherein a height of the first photo spacer is greater than a height of the second photo spacer, and in at least one of the two directions, a width of a target end face of the second photo spacer is greater than the width of the first opening face of the via hole.

3. The liquid crystal display panel according to claim 2, wherein an area of a target end face of the first photo spacer is less than an area of the first opening face of the via hole.

4. The liquid crystal display panel according to claim 3, wherein a minimum distance between the first photo spacer and the via hole is greater than a minimum distance between the second photo spacer and the via hole.

5. The liquid crystal display panel according to claim 1, wherein
the two directions comprise a first direction and a second direction that are intersected with each other; and the liquid crystal display panel comprises a plurality of sub-pixel regions; wherein
a width of the sub-pixel region in the first direction is less than a width of the sub-pixel region in the second direction;
the width of the first opening face of the via hole in the first direction is less than the width of the first opening face of the via hole in the second direction; and
the width of the target end face of the photo spacer in the first direction is greater than the width of the target end face of the photo spacer in the second direction, and greater than the width of the first opening face of the via hole in the first direction.

6. The liquid crystal display panel according to claim 1, wherein the target end face of the photo spacer is circular or rectangular; and the first opening face of the via hole is circular or octagonal.

7. The liquid crystal display panel according to claim 1, wherein in at least one of the two directions, a difference between the width of target end face of the photo spacer and the width of the first opening face of the via hole ranges from 2 μm to 10 μm.

8. The liquid crystal display panel according to claim 1, wherein in the two directions, the width of the first opening face of the via hole ranges from 10 μm to 16 μm, and a width of a second opening face of the via hole ranges from 6 μm to 12 μm, wherein the second opening face of the via hole is an opening face, distal form the color filter substrate, of the via hole.

9. The liquid crystal display panel according to claim 1, wherein
the array substrate comprises: an organic insulative layer, a plurality of thin-film transistors disposed on a side of the organic insulative layer, and a plurality of pixel electrodes disposed on the other side of the organic insulative layer, wherein the plurality of via holes are disposed in the organic insulative layer, and the pixel electrode is electrically connected to the thin-film transistor by the via hole.

10. A display device, comprising: a backlight source and a liquid crystal display panel;
wherein the liquid crystal display panel comprises:
an array substrate and a color filter substrate that are arranged oppositely, wherein the array substrate is provided with a plurality of via holes, the plurality of via holes being arranged in an array along two directions; and
a plurality of photo spacers disposed between the array substrate and the color filter substrate;
wherein in at least one of the two directions, widths of target end faces of at least part of the plurality of photo spacers are greater than widths of first opening faces of the via holes, wherein the target end face of the photo spacer is an end face, proximal to the array substrate, of the photo spacer, and the first opening face of the via hole is an opening face, proximal to the color filter substrate, of the via hole.

11. The liquid crystal display panel according to claim 9, wherein the array substrate further comprises: a plurality of gate lines and a plurality of data lines that are electrically connected to the plurality of thin-film transistors, wherein the plurality of gate lines are crosswise arranged with the plurality of data lines, an orthographic projection of the photo spacers on the array substrate being overlapped with a cross region between the gate lines and the data lines.

12. The display device according to claim 10, wherein the plurality of photo spacers comprise: a plurality of first photo spacers and a plurality of second photo spacers, wherein a height of the first photo spacer is greater than a height of the second photo spacer, and in at least one of the two directions, a width of a target end face of the second photo spacer is greater than the width of the first opening face of the via hole.

13. The display device according to claim 11, wherein an area of a target end face of the first photo spacer is less than an area of the first opening face of the via hole.

14. The display device according to claim 12, wherein a minimum distance between the first photo spacer and the via hole is greater than a minimum distance between the second photo spacer and the via hole.

15. The display device according to claim 10, wherein
the two directions comprise a first direction and a second direction that are intersected with each other; and the liquid crystal display panel comprises a plurality of sub-pixel regions; wherein
a width of the sub-pixel region in the first direction is less than a width of the sub-pixel region in the second direction;
the width of the first opening face of the via hole in the first direction is less than the width of the first opening face of the via hole in the second direction; and
the width of the target end face of the photo spacer in the first direction is greater than the width of the target end face of the photo spacer in the second direction, and greater than the width of the first opening face of the via hole in the first direction.

16. The display device according to claim 10, wherein the target end face of the photo spacer is circular or rectangular; and the first opening face of the via hole is circular or octagonal.

17. The display device according to claim 10, wherein in at least one of the two directions, a difference between the width of target end face of the photo spacer and the width of the first opening face of the via hole ranges from 2 μm to 10 μm.

18. The display device according to claim 10, wherein in the two directions, the width of the first opening face of the via hole ranges from 10 μm to 16 μm, and a width of a second opening face of the via hole ranges from 6 μm to 12 μm, wherein the second opening face of the via hole is an opening face, distal form the color filter substrate, of the via hole.

19. The display device according to claim 10, wherein the array substrate comprises: an organic insulative layer, a plurality of thin-film transistors disposed on a side of the organic insulative layer, and a plurality of pixel electrodes disposed on the other side of the organic insulative layer, wherein the plurality of via holes are disposed in the organic insulative layer, and the pixel electrode is electrically connected to the thin-film transistor by the via hole.

20. The display device according to claim 19, wherein the array substrate further comprises: a plurality of gate lines and a plurality of data lines that are electrically connected to the plurality of thin-film transistors, wherein the plurality of gate lines are crosswise arranged with the plurality of data lines, an orthographic projection of the photo spacers on the array substrate being overlapped with a cross region between the gate lines and the data lines.
